(19) United States
(12) Patent Application Publication
(10) Pub. No.: US 2006/0081601 A1
(43) Pub. Date: Apr. 20, 2006

(54) Device for heating or cooling workpieces and manufacturing method therefor

(75) Inventors: Jun Futakuchiya, Isehara-shi (JP); Toshihiro Tachikawa, Isehara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: NHK Spring Co., Ltd., Yokohama-shi (JP)

(21) Appl. No.: 11/194,424

(22) Filed: Aug. 1, 2005

(30) Foreign Application Priority Data
Aug. 4, 2004 (JP) 2004-228395

(51) Int. Cl. H05B 3/68

(52) U.S. Cl. 219/444.1; 118/724

(57) ABSTRACT

A heater unit comprises a shaft member and a plate member. The shaft member has a body and a flange portion formed on an end portion of the shaft body. The plate member is formed by brazing a plurality of plate elements together. One of the plate elements has a recess in which the flange portion is inserted. A gap is formed between a peripheral surface of the flange portion and an inner peripheral surface of the recess. An end face of the flange portion is brazed to the plate element in a manner such that the flange portion is inserted into the recess and the flange portion is loaded and heated by a pressurizing jig.

### CROSS-REFERENCE TO RELATED APPLICATIONS

This application is based upon and claims the benefit of priority from prior Japanese Patent Application No. 2004-228395, filed Aug. 4, 2004, the entire contents of which are incorporated herein by reference.

### BACKGROUND OF THE INVENTION

1. Field of the Invention

This invention relates to a device used to heat or cool workpieces, such as semiconductor wafers, in a semiconductor manufacturing process or the like.

2. Description of the Related Art

A process chamber having a heater unit for heating semiconductor wafers is used in a semiconductor manufacturing process, for example. In a heater unit described in Jpn. Pat. Appln. KOKAI Publication No. 2001-326181 (patent document 1), the outer periphery of the upper end of, e.g., a columnar shaft is fixed to the lower surface of a plate with a heating element by brazing or beam welding. The lower end of the shaft is fixed to a bottom wall of the process chamber by brazing or welding.

In a semiconductor wafer heating device proposed and described in Jpn. Pat. No. 2525974 (patent document 2), moreover, a cylindrical body through which conductor wires are passed is fixed to a ceramic heater by being bonded to a predetermined portion of a disc-shaped ceramic base with titanium-doped gold or silver solder or glass.

In the heater unit described in the patent document 1, the area of junctions (brazed or welded portions) between the plate and the shaft is so narrow that thermal stress is readily concentrated on the junctions. If an excessive stress is concentrated on the junctions, there is a possibility of the junctions or the like being broken. If the plate is formed by lapping a plurality of plate elements, a process for brazing the plate elements together must be executed independently of a process for bonding the plate to the shaft. Thus, the manufacture requires a lot of man-hours and entails high cost.

In the case of the semiconductor wafer heating device described in the patent document 2, brazed junctions between the cylindrical body and the disc-shaped ceramic base are not very strong. Therefore, the junctions may be separated depending on the magnitude of the thermal stress. If a heavy load is applied to the ceramic cylindrical body and the ceramic base during brazing operation, moreover, these parts may possibly be broken.

### BRIEF SUMMARY OF THE INVENTION

Accordingly, the object of the present invention is to provide a device for heating or cooling workpieces, capable of applying an appropriate load for brazing to a shaft member and a plate member without causing joints between the shaft member and the plate member to be broken by thermal stress, and a manufacturing method therefor.

According to the present invention, there is provided a device for heating or cooing workpieces, comprising: a shaft member having a shaft body and a flange portion which is molded integrally with the shaft body on an end portion of the shaft body and has a diameter greater than the diameter of the shaft body; a plate member fixed to an end portion of the shaft member and having a recess in which the flange portion is housed; a positioning portion which radially positions the flange portion with respect to the plate member; a gap formed between a peripheral surface of the flange portion and an inner peripheral surface of the recess; and a brazed portion which bonds an end face of the flange portion and the plate member together in the recess.

According to this arrangement, the end face of the flange portion formed on the shaft member can be brazed to the plate member in a wide area in the recess of the plate member, and the brazed portion and other parts can be prevented from being broken by thermal stress. When the flange portion of the shaft member is inserted into the recess of the plate member, the flange portion and the plate member can be pressurized by a common pressurizing jig. An appropriate load for brazing can be applied to the brazed portion between the flange portion and the plate member, and the flange portion and the plate member can be brazed simultaneously.

An example of a material for the shaft member and the plate member is a metal, such as aluminum or an aluminum alloy.

Preferably, the plate member is formed by lapping a plurality of plate elements in the thickness direction thereof and brazing the plate elements together, and the brazed portion between the plate elements extends parallel to the end face of the flange portion. Further, a reverse surface of the flange portion and a reverse surface of the plate member may be situated substantially flush with each other.

A manufacturing method according to the present invention is a method for manufacturing a device for heating or cooing workpieces, the device having a shaft member and a plate member which is fixed to an end portion of the shaft member and formed of a plurality of plate elements lapped in the thickness direction thereof, comprising: forming a flange portion having a diameter greater than the diameter of the shaft member on the end portion of the shaft member; forming a recess for insertion of the flange portion in that one of the plate elements to which the flange portion is brazed, the depth of the recess being smaller than the thickness of the flange portion, the flange portion having a diameter such that a gap is formed between an inner peripheral surface of the recess and a peripheral surface of the flange portion when the flange portion is inserted in the recess; locating a brazing material between the plate elements; lapping the plate elements on one another; locating a brazing material between an end face of the flange portion and the plate element to which the flange portion is brazed; inserting the flange portion into the recess; pressurizing a reverse surface of the flange portion in an axial direction of the shaft member by a pressurizing jig; reducing the thickness of the flange portion by the pressurization so that the peripheral surface of the flange portion is allowed to extend by the gap; pressurizing both the flange portion and the plate element in the axial direction with the pressurizing jig in contact with the reverse surface of the flange portion and a reverse surface of the plate element after the reverse surface of the flange portion is made flush with the reverse surface of the plate element by the pressurization; heating the flange portion and the plate element to a temperature such that the brazing materials melt; and brazing the flange portion and the plate element and brazing the plate elements together.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view of a heater unit according to an embodiment of the invention;

FIG. 2 is a sectional view showing a shaft member, plate elements, and brazing materials of the heater unit before brazing;

FIG. 3 is a perspective view a state in which the plate elements shown in FIG. 2 are placed on a jig;

FIG. 4 is a sectional view showing a part of the heater unit before brazing; and

FIG. 5 is a sectional view showing a part of the heater unit after brazing.

### DETAILED DESCRIPTION OF THE INVENTION

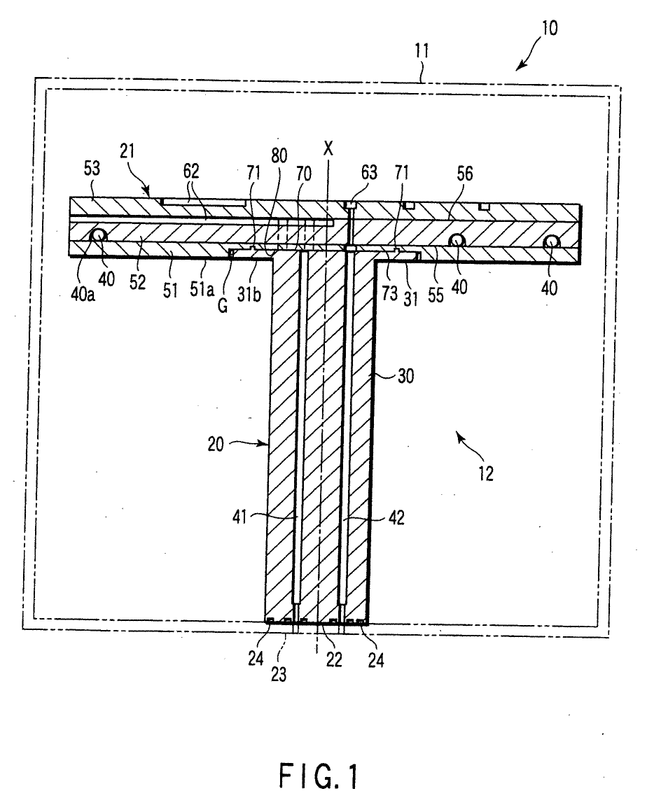

An embodiment of the present invention will now be described with reference to FIGS. 1 to 5.

FIG. 1 shows a processor 10 used in, for example, a semiconductor manufacturing process. The processor 10 comprises a process chamber 11 that constitutes a sealable case, a heater unit 12 housed in the chamber 11, etc. The heater unit 12 is an example of a device for heating workpieces.

The heater unit 12 has a shaft member 20 that serves as a support and a plate member 21 fixed to an upper end of the shaft member 20. A lower end 22 of the shaft member 20 is fixed to a bottom wall 23 of the process chamber 11. A sealing material (not shown) for sealing a space between the shaft member 20 and the bottom wall 23 is provided in a groove that is formed in the lower end 22 of the shaft member 20.

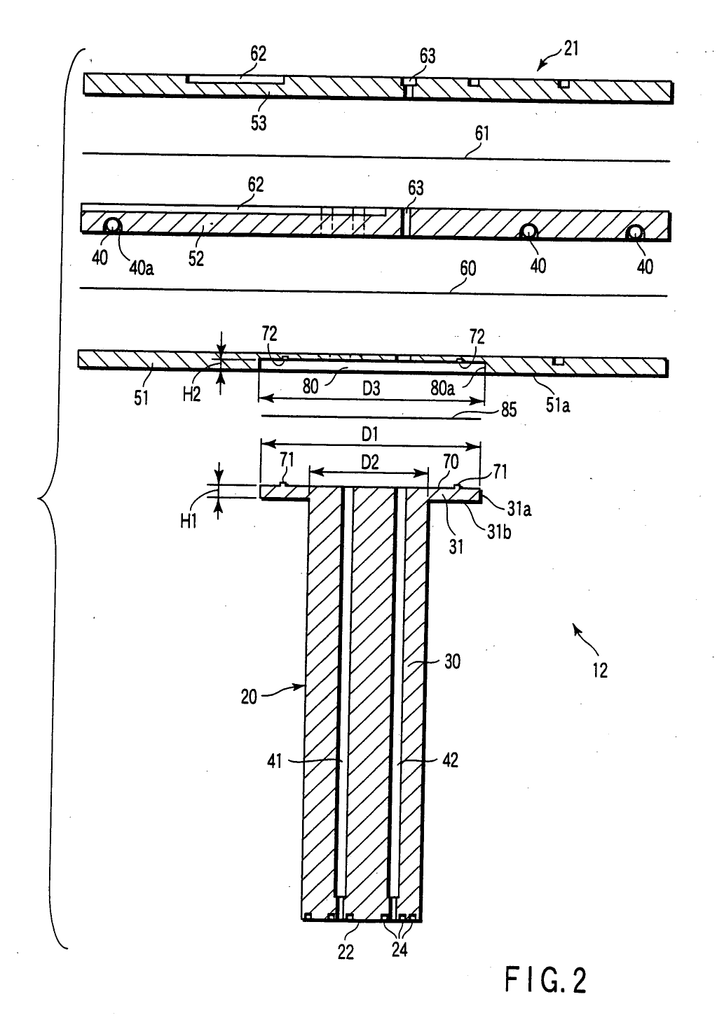

The shaft member 20 has a vertically extending shaft body 30 and a disc-shaped flange portion 31 that is molded integrally on the upper end portion of the shaft body 30. The shaft body 30 is a solid member of aluminum or an aluminum alloy, for example. An axis X of the shaft body 30 extends vertically. A diameter D1 (FIG. 2) of the flange portion 31 is greater than a transverse dimension D2 of the shaft body 30.

As shown in FIG. 1, a resistance heating element 40 (only a sheath of which is shown) as an example of a heating element is provided in the plate member 21. The heating element 40 is housed in a groove 40a in the plate member 21. Through holes 41 and 42 that extend along the axis X of the shaft body 30 are formed in the shaft member 20. Conductor wires (not shown) that conduct with the heating element 40 are passed through the one through hole 41. When the heater unit 12 is in operation, a semiconductor wafer (not shown) as an example of a workpiece is placed on the upper surface of the plate member 21.

The plate member 21 is formed by, for example, lapping three plate elements 51, 52 and 53 in their thickness direction and brazing them together. As shown in FIG. 1, a brazed portion 55 is formed between the first and second plate elements 51 and 52, and a brazed portion 56 between the second and third plate elements 52 and 53.

All the plate elements 51, 52 and 53, like the shaft member 20, are formed of aluminum or an aluminum alloy and are substantially circular. They have substantially equal outside diameters.

The first and second elements 51 and 52 are joined together by a brazing material 60 shown in FIG. 2. The second and third plate elements 52 and 53 are joined together by a brazing material 61. If necessary, a groove 62 or a hole 63 is formed in a given position in each of the plate elements 51 and 52.

Small protrusions 71 that extend in the direction of the axis X are formed in a plurality of spots on an end face 70 of the flange portion 31. The first plate element 51 is formed with holes 72 in which the protrusions 71 can be fitted individually. The flange portion 31 and the plate element 51 to which the flange portion 31 is brazed can be radially positioned with respect to each other by inserting the protrusions 71 into the holes 72, individually. The small protrusions 71 and the holes 72 serve as positioning portions.

A brazed portion 73 (FIG. 1) is formed between the end face 70 of the flange portion 31 and the first plate element 51. The brazed portion 73 extends parallel to the brazed portions 55 and 56 between the plate elements 51, 52 and 53. The brazed portions 55, 56 and 73 extend parallel to the end face 70 of the flange portion 31.

The first plate element 51 is formed having a circular recess 80 that is large enough to house the flange portion 31. Before the flange portion 31 is brazed, its thickness H1 (FIG. 2) is a little greater than a depth H2 of the recess 80.

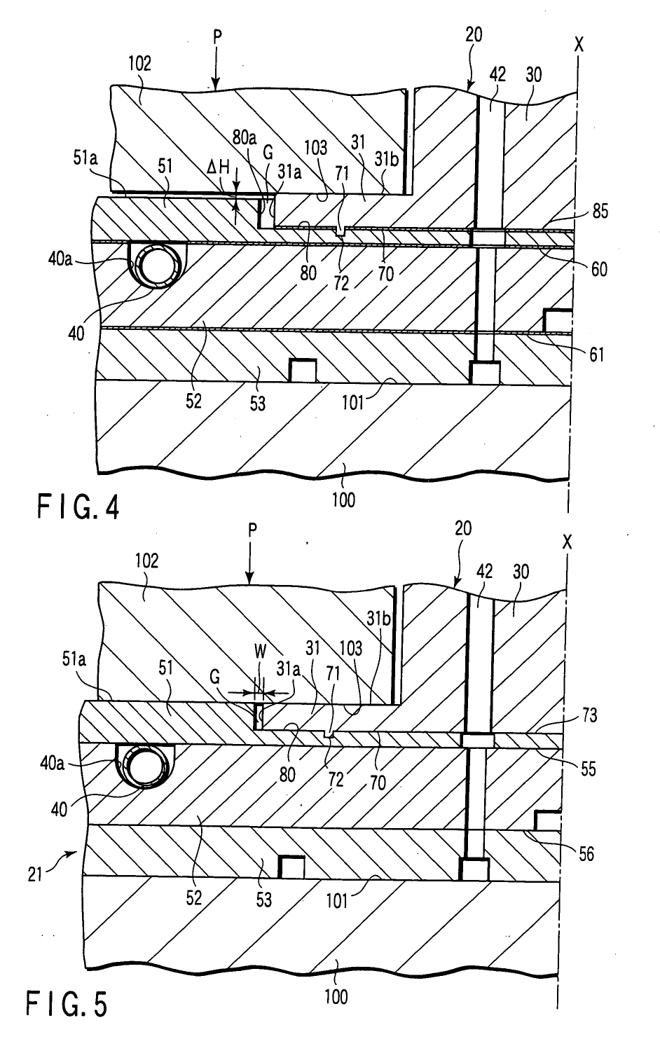

Further, an outside diameter D1 of the flange portion 31 is a little smaller than an inside diameter D3 of the recess 80. When the flange portion 31 is inserted in the recess 80, therefore, a gap G (FIG. 4) of about 0.2 mm to 2.0 mm is formed between a peripheral surface 31a of the flange portion 31 and an inner peripheral surface 80a of the recess 80, covering the entire circumference of the flange portion 31.

The end face 70 of the flange portion 31 and the first plate element 51 are bonded to each other in the recess 80 with a brazing material 85 shown in FIG. 2. The brazing material 85, like the brazing materials 60 and 61, is a foil formed of aluminum doped with silicon or the like, for example. The brazing materials 60, 61 and 85 have a thickness of several tens of μm, for example.

The following is a description of a manufacturing method for the heater unit 12.

As shown in FIG. 2, the brazing material 60 is interposed between the first and second plate elements 51 and 52. Likewise, the brazing material 61 is interposed between the second and third plate elements 52 and 53. Further, the brazing material 85 is interposed between the flange portion 31 and the first plate element 51.

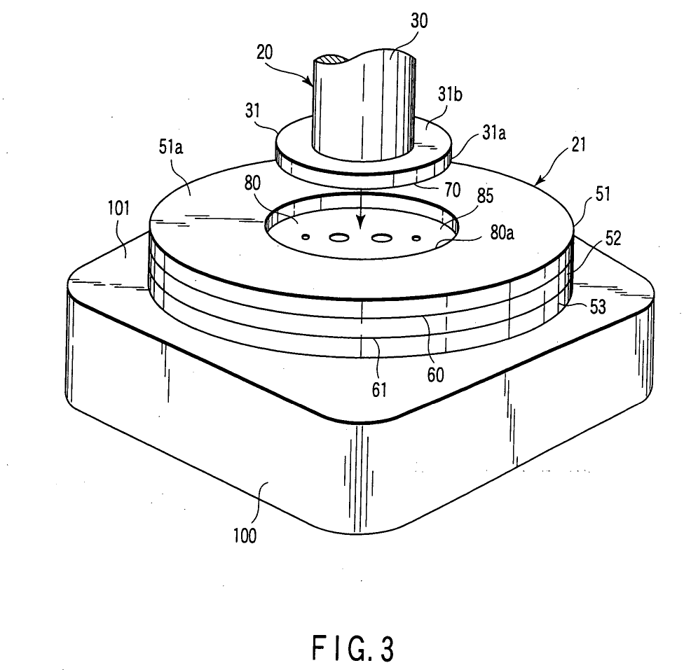

As shown in FIG. 3, the plate elements 51 to 53, held upside down as compared with the position shown in FIG. 1, are placed on a flat support surface 101 of a receiving jig 100. Further, the flange portion 31 is inserted into the recess 80 of the first plate element 51. As the protrusions 71 that serve as the positioning portions are then fitted individually into the holes 72, the flange portion 31 is radially positioned with respect to the first plate element 51, and the gap G is formed covering the entire circumference of the flange portion 31.

As shown in FIG. 4, a flat pressurizing surface 103 of a pressurizing jig 102 is brought into contact with a reverse surface 31b (upper surface in FIG. 4) of the flange portion 31. Then, in a vacuum oven, the flange portion 31 and the plate elements 51, 52 and 53 are heated to a temperature (e.g., 500° C.) such that the brazing materials 60, 61 and 85 are melted and diffused, and are subjected to a load P in the direction of the axis X by the pressurizing jig 102.

Before the load P is applied to the flange portion 31, the thickness H1 of the flange portion 31 is greater than the depth H2 of the recess 80. Therefore, the reverse surface 31b of the flange portion 31 is higher than a reverse surface 51a (upper surface in FIG. 4) of the first plate element 51 by a difference AH (FIG. 4) between the thickness H1 of the flange portion 31 and the depth H2 of the recess 80.

If the load P in the direction of the axis X is applied to the flange portion 31 by the pressurizing jig 102 in this state, the jig 102 pressurizes only the flange portion 31 in the beginning. In this situation, the flange portion 31 and the respective central parts of the plate elements 51, 52 and 53 are mainly pressurized in the thickness direction by the receiving jig 100 and the pressurizing jig 102.

If the flange portion 31 is flattened to some extent in the thickness direction by the load P, its thickness H1 lessens. If the thickness H1 of the flange portion 31 is thus reduced, the peripheral surface 31a of the flange portion 31 extends in its radial direction, so that a width W of the gap G becomes narrower. However, the gap G allows the peripheral surface 31a of the flange portion 31 to extend.

If the thickness H1 of the flange portion 31 becomes equal to the depth H2 of the recess 80, the pressurizing surface 103 of the pressurizing jig 102 touches both reverse surface 31b of the flange portion 31 and the reverse surface 51a of the first plate element 51, as shown in FIG. 5. Thus, the pressurizing jig 102 pressurizes both the flange portion 31 and the first plate element 51 in the direction of the axis X. In this state, the flange portion 31 and the plate elements 51, 52 and 53 are wholly pressurized in the thickness direction.

By the pressurization in the direction of the axis X and heating, the brazing materials 60, 61 and 85 are melted and diffused into aluminum in the flange portion 31 and the plate elements 51, 52 and 53. Thereupon, the brazed portions 55, 56 and 73 are brazed simultaneously. Thus, the brazing material 85 between the flange portion 31 and the first plate element 51 diffuses into their respective bonding surfaces, whereupon the flange portion 31 and the first plate element 51 are firmly bonded together.

At the same time, the brazing material 60 between the first and second plate elements 51 and 52 diffuses into their respective bonding surfaces, whereupon the plate elements 51 and 52 are firmly bonded together. Further, the brazing material 61 between the second and third plate elements 52 and 53 diffuses into their respective bonding surfaces, whereupon the plate elements 52 and 53 are firmly bonded together.

As described above, the flange portion 31 and the plate elements 51, 52 and 53 are simultaneously pressurized in the thickness direction as the brazing materials 60, 61 and 85 are melted and diffused. By one hot-press process, therefore, brazing of the three brazed portions 55, 56 and 73 can be completed efficiently. In the heater unit 12, the brazed portion 73 that extends along the end face 70 of the flange portion 31 is parallel to the brazed portions 55 and 56 between the plate elements 51, 52 and 53. Therefore, the three brazed portions 55, 56 and 73 can be simultaneously pressurized by the load P that acts in the direction of the axis X.

After the brazing, the reverse surface 31b of the flange portion 31 and the reverse surface 51a of the plate element 51 may be ground to a given thickness by machining. Further, the shaft member 20 and the plate elements 51, 52 and 53 may be formed of any other metallic material than an aluminum alloy. The plate member may be composed of one or two plate elements or three or more plate elements. The positioning portions may be of various other forms than the protrusions 71 and the holes 72.

In connection with the foregoing embodiment, the heater unit 12 has been described as a device for heating workpieces. Alternatively, however, the present invention may be also applied to a device for cooling workpieces. In the workpiece cooling device, a plate member is formed having grooves or holes through which a cooling medium is circulated.

For example, the plate member 21 may be used for the workpiece cooling device if the cooling medium is run through its groove 40a (FIG. 1) by a refrigerant circuit instead of housing the resistance heating element 40 in the groove 40a. Alternatively, a refrigerant circulation pipe may be housed in the groove in the plate member so that the plate member can be cooled by connecting the refrigerant circuit to the refrigerant pipe.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A device for heating or cooing workpieces, comprising:
a shaft member having a shaft body and a flange portion which is molded integrally with the shaft body on an end portion of the shaft body and has a diameter greater than the diameter of the shaft body;
a plate member fixed to an end portion of the shaft member and having a recess in which the flange portion is housed;
a positioning portion which radially positions the flange portion with respect to the plate member;
a gap formed between a peripheral surface of the flange portion and an inner peripheral surface of the recess; and
a brazed portion which bonds an end face of the flange portion and the plate member together in the recess.

2. A device for heating or cooling workpieces according to claim 1, wherein the shaft member and the plate member are formed of a metal.

3. A device for heating or cooling workpieces according to claim 2, wherein the shaft member and the plate member are formed of aluminum or an aluminum alloy.

4. A device for heating or cooling workpieces according to claim 1, wherein the plate member is formed by lapping a plurality of plate elements in the thickness direction thereof and brazing the plate elements together, and the brazed portion between the plate elements extends parallel to the end face of the flange portion.

5. A device for heating or cooling workpieces according to claim 1, wherein a reverse surface of the flange portion and a reverse surface of the plate member are situated substantially flush with each other.

6. A manufacturing method for a device for heating or cooing workpieces, the device having a shaft member and a plate member which is fixed to an end portion of the shaft member and formed of a plurality of plate elements lapped in the thickness direction thereof, comprising:
forming a flange portion having a diameter greater than the diameter of the shaft member on the end portion of the shaft member;
forming a recess for insertion of the flange portion in that one of the plate elements to which the flange portion is brazed, the depth of the recess being smaller than the thickness of the flange portion, the flange portion having a diameter such that a gap is formed between an inner peripheral surface of the recess and a peripheral surface of the flange portion when the flange portion is inserted in the recess;
locating a brazing material between the plate elements;
lapping the plate elements on one another;
locating a brazing material between an end face of the flange portion and the plate element to which the flange portion is brazed;
inserting the flange portion into the recess;
pressurizing a reverse surface of the flange portion in an axial direction of the shaft member by a pressurizing jig;
reducing the thickness of the flange portion by the pressurization so that the peripheral surface of the flange portion is allowed to extend by the gap;
pressurizing both the flange portion and the plate element in the axial direction with the pressurizing jig in contact with the reverse surface of the flange portion and a reverse surface of the plate element after the reverse surface of the flange portion is made flush with the reverse surface of the plate element by the pressurization;
heating the flange portion and the plate element to a temperature such that the brazing materials melt; and
brazing the flange portion and the plate element and brazing the plate elements together.
